(19) United States
(12) Patent Application Publication
(10) Pub. No.: US 2013/0224098 A1
(43) Pub. Date: Aug. 29, 2013

(54) USE OF A REACTOR WITH INTEGRATED HEAT EXCHANGER IN A PROCESS FOR HYDRODECHLORINATING SILICON TETRACHLORIDE

(71) Applicants: Günter Latoschinski, Marl (DE); Yücel Önal, Carl Junction, MO (US); Jörg Sauer, Karlsruhe (DE); Guido Stochniol, Haltern am See (DE); Ingo Pauli, Schmitten (DE)

(72) Inventors: Günter Latoschinski, Marl (DE); Yücel Önal, Carl Junction, MO (US); Jörg Sauer, Karlsruhe (DE); Guido Stochniol, Haltern am See (DE); Ingo Pauli, Schmitten (DE)

(73) Assignee: Evonik Degussa GmbH, Essen (DE)

(21) Appl. No.: 13/816,569

(22) PCT Filed: Jul. 13, 2011
(86) PCT No.: PCT/EP2011/061911

§ 371 Date: May 16, 2013

(30) Foreign Application Priority Data
Aug. 12, 2010 (DE) 10 2010 039 267.7

(51) Int. Cl. B01J 3/04

(52) U.S. Cl. CPC B01J 3/042
USPC 423/342

(57) ABSTRACT

The invention relates to a method for converting silicon tetrachloride by means of hydrogen to form trichlorosilane in a modified hydrodechlorination reactor. The invention further relates to a the use of such a modified hydrodechlorination reactor as an integrated component of a system for producing trichlorosilane from metallurgical silicon.

The invention relates to a process for reacting silicon tetrachloride with hydrogen to give trichlorosilane in a modified hydrodechlorination reactor. The invention further relates to the use of such a modified hydrodechlorination reactor as an integral part of a plant for preparing trichlorosilane from metallurgical silicon.

In many industrial processes in silicon chemistry, SiCl₄ and HSiCl₃ form together. It is therefore necessary to interconvert these two products and hence to satisfy the particular demand for one of the products.

Furthermore, high-purity HSiCl₃ is an important feedstock in the production of solar silicon.

In the hydrodechlorination of silicon tetrachloride (STC) to trichlorosilane (TCS), the industrial standard is the use of a thermally controlled process in which the STC is passed together with hydrogen into a graphite-lined reactor, known as the “Siemens furnace”. The graphite rods present in the reactor are operated in the form of resistance heating, and so temperatures of 1100° C. or higher are attained. By virtue of the high temperature and the hydrogen component, the equilibrium position is shifted toward the TCS product. The product mixture is conducted out of the reactor after the reaction and removed in complex processes. The flow through the reactor is continuous, and the inner surfaces of the reactor must consist of graphite, being a corrosion-resistant material. For stabilization, an outer metal shell is used. The outer wall of the reactor has to be cooled in order to very substantially suppress the decomposition reactions which occur at the high temperatures at the hot reactor wall, and which can lead to silicon deposits.

In addition to the disadvantageous decomposition owing to the necessary and uneconomic very high temperature, the regular cleaning of the reactor is also disadvantageous. Owing to the restricted reactor size, a series of independent reactors has to be operated, which is economically likewise disadvantageous. The present technology does not allow operation under pressure in order to achieve a higher space-time yield, in order thus, for example, to reduce the number of reactors.

A further disadvantage is the performance of a purely thermal reaction without a catalyst, which makes the process very inefficient overall.

It is likewise disadvantageous that, in conventional systems, heat exchanger systems and reactors are separated, and so an increased level of losses has to be accepted in the efficiency of these spatially separate systems.

Furthermore, in the case of use of ceramic tubes, the maximum permissible temperature in the sealing region of ceramic to metal is limited to the maximum permissible temperature of sealing materials, such that there is generally only very inefficient utilization of the hot reaction discharge.

It was thus an object of the present invention to provide a process for reacting silicon tetrachloride with hydrogen, which works more efficiently and with which a higher conversion can be achieved with comparable reactor size, which means that the space-time yield of TCS is increased significantly. In addition, the process according to the invention should enable a high selectivity for TCS.

To solve the problem, it has been found that a mixture of STC and hydrogen can be conducted through a pressurized reaction chamber, preferably a tubular reactor, which may preferably be equipped with a catalytic wall coating and/or with a fixed bed catalyst, preference being given to providing a catalytic wall coating, and the use of a fixed bed catalyst being merely optional.

The inventive configuration with a second tube which is within the reaction chamber and through which the STC and H₂ reactants flow and are also heated by the reaction chamber enables a comparatively compact design, it being possible to dispense with expensive inert materials or catalytically coated supports which may bind a high proportion of noble metals.

The combination of the use of a catalyst to improve the reaction kinetics and enhance the selectivity, and a pressurized reaction with integrated flow tube for heat exchange, ensures an economically and ecologically very efficient process regime. Suitable adjustment of the reaction parameters, such as pressure, residence time, ratio of hydrogen to STC, can give a process in which high space-time yields of TCS are obtained with a high selectivity.

The utilization of a suitable catalyst in conjunction with pressure constitutes a special feature of the process, since sufficiently high amounts of TCS can thus be obtained at comparatively low temperatures of distinctly below 1000° C., preferably below 950° C., without having to accept significant losses as a result of the thermal decomposition.

It has been found that particular ceramic materials can be used for the reaction chamber and the integrated heat exchanger since they are sufficiently inert and ensure the pressure resistance of the reactor even at high temperatures, for example 1000° C., without the ceramic material passing through a phase conversion, for example, which would damage the structure and thus adversely affect the mechanical durability. In this context, it is necessary to use a gas-tight reaction chamber. Gas-tightness and inertness can be achieved by high-temperature-resistant ceramics which are specified in detail below.

The reaction chamber material and the heat exchanger material can be provided with a catalytically active internal coating. An inert bulk material for improving the flow dynamics can be dispensed with.

The dimensions of the reaction chamber with integrated heat exchanger and the design of the complete hydrodechlorination reactor are determined by the availability of the reaction chamber geometry, and by the requirements regarding the introduction of the heat required for the reaction regime. The reaction chamber may be either a single reaction tube with the corresponding peripheral equipment or a combination of many reactor tubes. In the latter case, the arrangement of many reactor tubes in a heated chamber may be advisable, in which the amount of heat is introduced, for example, by natural gas burners. In order to avoid a local temperature peak on the reactor tubes, the burners should not be directed at the tubes. They can, for example, be aligned indirectly into the reactor space from above and be distributed over the reactor space. To enhance the energy efficiency, the reactor system is connected to a heat recovery system by the integrated heat exchanger.

The inventive solution to the abovementioned problem is described in detail hereinafter, including different or preferred embodiments.

The invention thus provides a process in which a silicon tetrachloride-containing reactant stream and a hydrogen-containing reactant stream are reacted in a hydrodechlorination reactor by supplying heat to form a trichlorosilane-containing and HCl-containing product mixture, characterized in that the process has the following further features: the silicon tetrachloride-containing reactant stream and/or the hydrogen-containing reactant stream are conducted under pressure into the pressurized hydrodechlorination reactor; the reactor comprises at least one flow tube which projects into a reaction chamber and through which one or both of the reactant streams is/are conducted into the reaction chamber; the product mixture is conducted out of the reaction chamber as a pressurized stream; the reaction chamber and optionally the flow tube consist(s) of a ceramic material; the product mixture formed in the reaction chamber is conducted out of the reaction chamber in such a way that the reactant/product stream in the interior of the reaction chamber is conducted at least partly along the outside of the flow tube which projects into the reaction chamber; heat is supplied through a heating jacket or heating space which at least partly surrounds the reaction chamber; and the reaction chamber comprises, downstream of the region of the reaction chamber heated by the heating jacket or heating space, an integrated heat exchanger which cools the heated product mixture, the heat removed being used to preheat the silicon tetrachloride-containing reactant stream and/or the hydrogen-containing reactant stream.

The equilibrium reaction in the hydrodechlorination reactor is performed typically at 700° C. to 1000° C., preferably at 850° C. to 950° C., and at a pressure in the range between 1 and 10 bar, preferably between 3 and 8 bar, more preferably between 4 and 6 bar.

In all described variants of the process according to the invention, the hydrodechlorination reactor may comprise a single flow tube through which both of the reactant streams are conducted together, or the reactor may comprise more than one flow tube through which both of the reactant streams are optionally conducted together into the reaction chamber in each of the flow tubes, or the different reactant streams can be conducted separately into the reaction chamber, each in different flow tubes.

The ceramic material for the reaction chamber, the integrated heat exchanger tubes and optionally the flow tube is preferably selected from Al₂O₃, AlN, Si₃N₄, SiCN and SiC, more preferably selected from Si-infiltrated SiC, isostatically pressed SiC, hot isostatically pressed SiC and SiC sintered at ambient pressure (SSiC).

In particular, reactors with an SiC-containing reaction chamber (for example one or more reactor tubes), riser tube(s) and precisely such integrated heat exchanger tubes are preferred, since they possess particularly good thermal conductivity, and enable homogeneous heat distribution and good heat input for the reaction, and also good thermal shock stability. It is particularly preferred when the reaction chamber, the riser tube(s) and the integrated heat exchanger tubes consist(s) of SiC sintered at ambient pressure (SSiC).

It is envisaged in accordance with the invention that the silicon tetrachloride-containing reactant stream and/or the hydrogen-containing reactant stream is/are preferably conducted into the hydrodechlorination reactor with a pressure in the range from 1 to 10 bar, preferably in the range from 3 to 8 bar, more preferably in the range from 4 to 6 bar, and with a temperature in the range from 150° C. to 900° C., preferably in the range from 300° C. to 800° C., more preferably in the range from 500° C. to 700° C.

In the case that the silicon tetrachloride-containing reactant stream is conducted into the hydrodechlorination reactor separately from the hydrogen-containing reactant stream, the silicon tetrachloride-containing reactant stream may be liquid or gaseous depending on the pressure applied and the temperature, while the hydrogen-containing reactant stream is typically gaseous. For instance, the liquid silicon tetrachloride-containing reactant stream can be supplied to the reactor chamber via a flow tube. However, the liquid silicon tetrachloride-containing reactant stream can also first be converted to the gas phase, preferably by means of heat exchangers, especially by utilizing the waste heat present, and conducted into the reactor chamber via a flow tube. In addition, the hydrogen-containing reactant stream can be passed into the reactor chamber via a separate flow tube. However, the hydrogen-containing reactant stream can also be supplied to a silicon tetrachloride-containing reactant stream which is preferably already present in gaseous form, and the mixture can be passed into the reactor chamber via a flow tube. In the case that both reactant streams are conducted together into the hydrodechlorination reactor, the combined reactant stream is preferably gaseous.

Heat can be supplied for the reaction in the hydrodechlorination reactor through a heating jacket which is heated by electrical resistance heating, or by means of a heating space. The heating space may also be a combustion chamber which is operated with combustion gas and combustion air.

It is particularly preferred in accordance with the invention that the reaction in the hydrodechlorination reactor is catalysed by an internal coating which catalyses the reaction in the reaction chamber (for example of the reactor tube(s)) and/or by a coating which catalyses the reaction in a fixed bed arranged within the reactor chamber.

The catalytically active coating(s), i.e. for the inner wall of the reactor and/or any fixed bed used, consist(s) preferably of a composition which comprises at least one active component selected from the metals Ti, Zr, Hf, Ni, Pd, Pt, Mo, W, Nb, Ta, Ba, Sr, Ca, Mg, Ru, Rh, Ir and combinations thereof, and silicide compounds thereof, especially Pt, Pt/Pd, Pt/Rh and Pt/Ir.

The inner wall of the reactor and/or any fixed bed used may be provided with the catalytically active coating as follows: by providing a suspension, also referred to hereinafter as coating material or paste, comprising a) at least one active component selected from the metals Ti, Zr, Hf, Ni, Pd, Pt, Mo, W, Nb, Ta, Ba, Sr, Ca, Mg, Ru, Rh, Ir and combinations thereof, and silicide compounds thereof, b) at least one suspension medium, and optionally c) at least one auxiliary component, especially for stabilizing the suspension, for improving the storage stability of the suspension, for improving the adhesion of the suspension to the surface to be coated and/or for improving the application of the suspension to the surface to be coated; by applying the suspension to the inner wall of the one or more reactor tubes and, optionally, by applying the suspension to the surface of random packings of any fixed bed provided; by drying the suspension applied; and by heat-treating the applied and dried suspension at a temperature in the range from 500° C. to 1500° C. under inert gas or hydrogen. The heat-treated random packings can then be introduced into the one or more reactor tubes. The heat treatment and optionally also the preceding drying may, however, also be effected with already introduced random packings.

The suspension media used in component b) of the inventive suspension, i.e. coating material or paste, especially those suspension media with binding character (also referred to as binders for short), may advantageously be thermoplastic polymeric acrylate resins as used in the paints and coatings industry. Examples include polymethyl acrylate, polyethyl acrylate, polypropyl methacrylate or polybutyl acrylate. These are systems customary on the market, for example those obtainable under the Degalan® brand name from Evonik Industries.

Optionally, the further components used, i.e. in the sense of component c), may advantageously be one or more auxiliaries or auxiliary components.

For instance, the auxiliary component c) used may optionally be solvent or diluent. Suitable with preference are organic solvents, especially aromatic solvents or diluents, such as toluene, xylenes, and also ketones, aldehydes, esters, alcohols or mixtures of at least two of the aforementioned solvents or diluents.

A stabilization of the suspension can—if required—advantageously be achieved by inorganic or organic rheology additives. The preferred inorganic rheology additives as component c) include, for example, kieselguhr, bentonites, smectites and attapulgites, synthetic sheet silicates, fumed silica or precipitated silica. The organic rheology additives or auxiliary components c) preferably include castor oil and derivatives thereof, such as polyamide-modified castor oil, polyolefin or polyolefin-modified polyamide, and polyamide and derivatives thereof, as sold, for example, under the Luvotix® brand name, and also mixed systems composed of inorganic and organic rheology additives.

In order to achieve an advantageous adhesion, the auxiliary components c) used may also be suitable adhesion promoters from the group of the silanes or siloxanes. Examples for this purpose include—though not exclusively—dimethyl-, diethyl-, dipropyl-, dibutyl-, diphenylpolysiloxane or mixed systems thereof, for example phenylethyl- or phenylbutylsiloxanes or other mixed systems, and mixtures thereof.

The inventive coating material or the paste may be obtained in a comparatively simple and economically viable manner, for example, by mixing, stirring or kneading the feedstocks (cf. components a), b) and optionally c)) in corresponding common apparatus known per se to those skilled in the art. In addition, reference is made to the present inventive examples.

The invention further provides for the use of a hydrodechlorination reactor as an integral part of a plant for preparing trichlorosilane from metallurgical silicon, characterized in that the reactor is operated under pressure; the reactor comprises at least one flow tube which projects into a reaction chamber for the entering reactant streams; the reaction chamber and optionally the flow tube consist(s) of a ceramic material; the reactant/product stream is conducted within the reaction chamber such that the reactant/product stream is conducted at least partly along the outside of the flow tube which projects into the reaction chamber; heat is supplied through a heating jacket or heating space which at least partly surrounds the reaction chamber; and the reaction chamber comprises, downstream of the region of the reaction chamber heated by the heating jacket or heating space, an integrated heat exchanger for cooling the heated product mixture. The hydrodechlorination reactor to be used in accordance with the invention may be as described above.

The plant for preparing trichlorosilane, in which the hydrodechlorination reactor can preferably be used, comprises:
a) a component plant for preparation of silicon tetrachloride with hydrogen to form trichlorosilane, comprising:
   a hydrodechlorination reactor (3) comprising a reaction chamber (21);
   a region of the reaction chamber (21) at least partly surrounded by a heating jacket (15) or a heating space (15);
   at least one line (1) for a silicon tetrachloride-containing reactant stream and at least one line (2) for a hydrogen-containing reactant stream, which lead into the hydrodechlorination reactor (3), a common line (1, 2) for the silicon tetrachloride-containing reactant stream and the hydrogen-containing reactant stream optionally being provided instead of separate lines (1) and (2);
   at least one flow tube (22) which projects into the reaction chamber (21) and through which a silicon tetrachloride-containing reactant stream (1) and/or a hydrogen-containing reactant stream (2) can be conducted into the reaction chamber (21), the reaction chamber (21) and optionally the flow tube (22) consisting of a ceramic material;
   an outlet for a product mixture (4) formed in the reaction chamber (21), the outlet being arranged such that the product mixture (4) can be conducted out of the reaction chamber (21) in the course of operation of the plant in such a way that the reactant/product stream is conducted within the reaction chamber (21) at least partly along the outside of the flow tube (22) which projects into the reaction chamber (21),
   a line (4) which is conducted out of the hydrodechlorination reactor (3) and is for a trichlorosilane-containing and HCl-containing product mixture;
   a heat exchanger (5) which is integrated within the hydrodechlorination reactor (3) and through which the product mixture line (4) and at least the one line (1) for the silicon tetrachloride-containing reactant stream and/or the at least one line (2) for the hydrogen-containing reactant stream are conducted such that heat transfer is possible from the product mixture line (4) into the at least one line (1) for the silicon tetrachloride-containing reactant stream and/or the at least one line (2) for the hydrogen-containing reactant stream, the integrated heat exchanger (5) being arranged downstream of the region of the reaction chamber (21) heated by the heating jacket (15) or heating space (15);
   optionally a component plant (7) or an arrangement comprising several component plants (7a, 7b, 7c) for removal of in each case one or more products comprising silicon tetrachloride, trichlorosilane, hydrogen and HCl;
   optionally a line (8) which conducts removed silicon tetrachloride into the line (1) for the silicon tetrachloride-containing reactant stream, preferably upstream of the heat exchanger (5);
   optionally a line (9) through which trichlorosilane removed is supplied to an end product withdrawal;
   optionally a line (10) which conducts hydrogen removed into the line (2) for the hydrogen-containing reactant stream, preferably upstream of the heat exchanger (5); and
   optionally a line (11) through which HCl removed is supplied to a plant for hydrochlorination of silicon; and
b) a component plant for reaction of metallurgical silicon with HCl to form silicon tetrachloride, comprising:
   a hydrochlorination plant (12) connected upstream of the component plant for reaction of silicon tetrachloride with hydrogen, at least a portion of the HCl used optionally being conducted into the hydrochlorination plant (12) via the HCl stream (11);
   a condenser (13) for removal of at least a portion of the hydrogen coproduct which originates from the reaction in the hydrochlorination plant (12), this hydrogen being conducted into the hydrodechlorination reactor (3) via the line (2) for the hydrogen-containing reactant stream;
   a distillation plant (14) for removal of at least silicon tetrachloride and trichlorosilane from the remaining product mixture which originates from the reaction in the hydrochlorination plant (12), the silicon tetrachloride being conducted into the hydrodechlorination reactor (3) via the line (1) for the silicon tetrachloride-containing reactant stream; and
in the case of a heating space (15) instead of a heating jacket (15):
   optionally a recuperator (16) for preheating the combustion air (19) provided for the heating space (15) with the flue gas (20) flowing out of the heating space (15); and
   optionally a plant (17) for raising steam from the flue gas (20) flowing out of the recuperator (16).

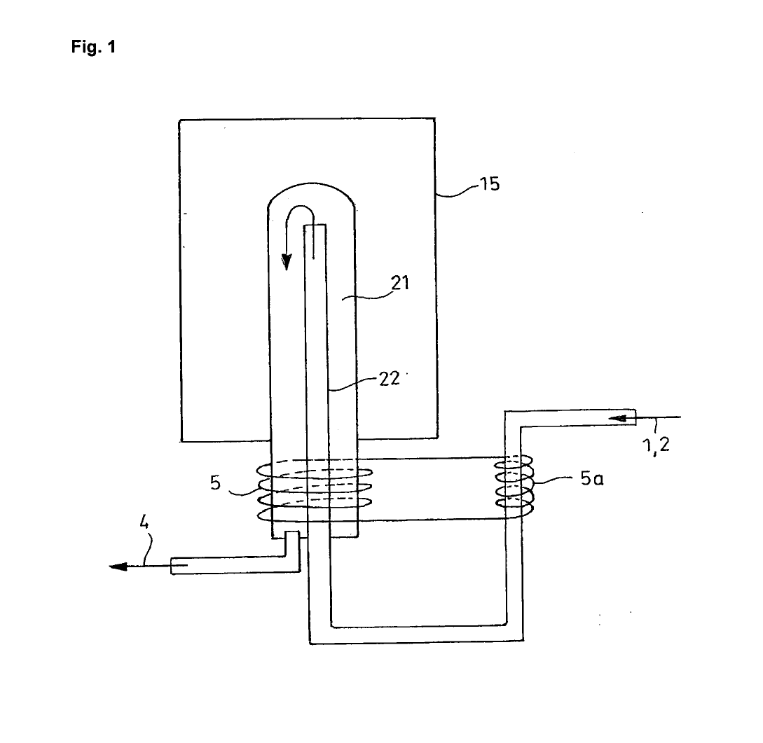

FIG. 1 shows, by way of example and schematically, a hydrodechlorination reactor which can be used in accordance with the invention in a process for reacting silicon tetrachloride with hydrogen to give trichlorosilane, or as an integral part of a plant for preparing trichlorosilane from metallurgical silicon.

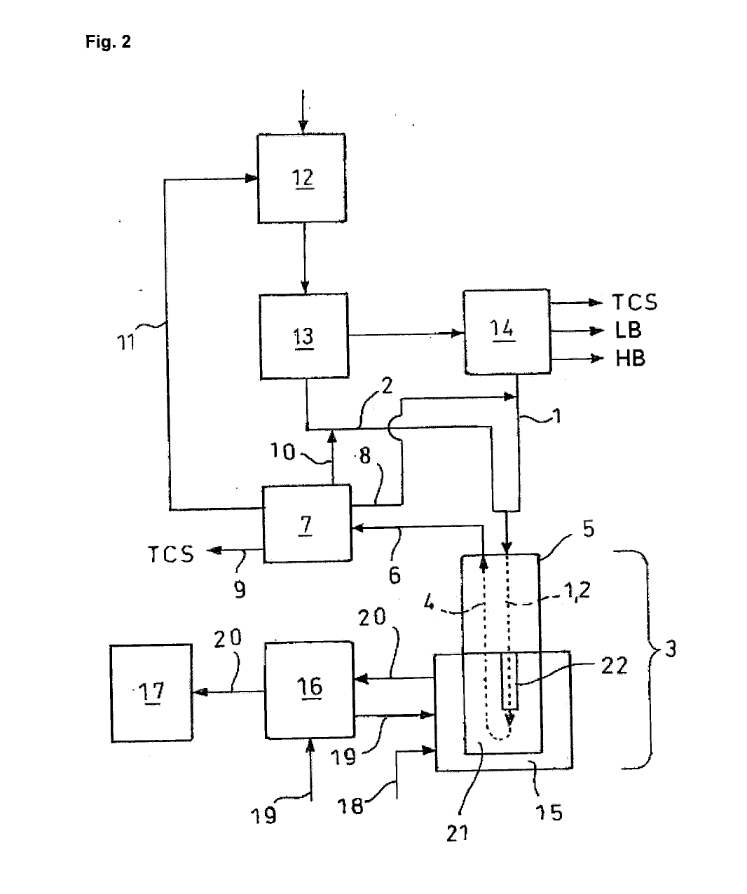

FIG. 2 shows, by way of example and schematically, a plant for preparing trichlorosilane from metallurgical silicon, in which the inventive hydrodechlorination reactor can be used.

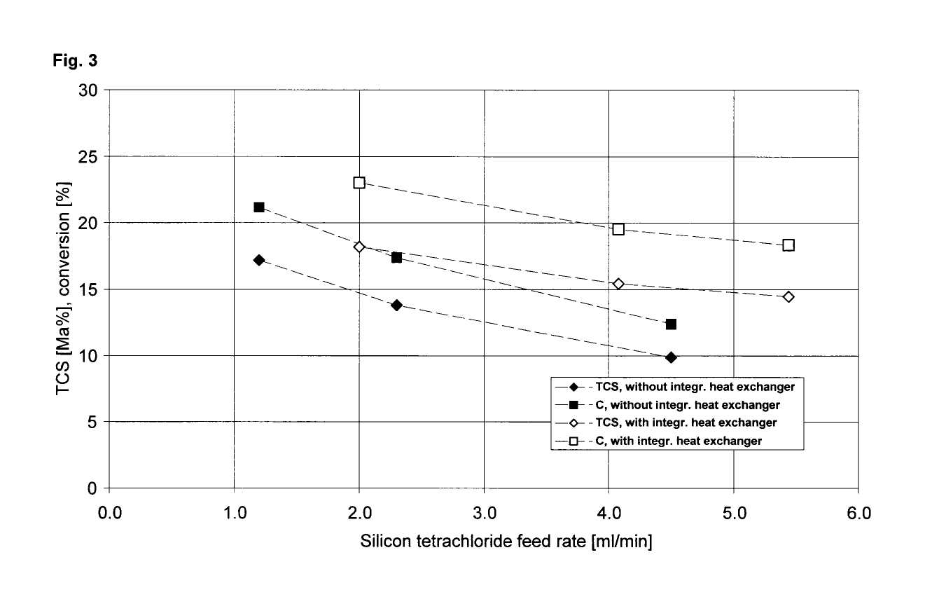

FIG. 3 shows a graph of the amount of TCS in the product (in ma%) as a function of the STC feed flow rate (in ml/min) and of the STC conversion (in %) as a function of the STC feed flow rate (in ml/min), in each case in accordance with the invention (with integrated heat exchanger) and not in accordance with the invention (without integrated heat exchanger).

The hydrodechlorination reactor 3 shown in FIG. 1 comprises a reaction chamber 21 arranged in a heating space 15, and a flow tube 22 which projects into the reaction chamber 21 and through which the reactant streams 1 and/or 2 can be conducted into the reaction chamber 21. Downstream of the region of the reaction chamber 21 heated by the heating space 15, an integrated heat exchanger 5 is shown, which is provided for cooling the heated product mixture in the line 4 conducted out of the reaction chamber 21, in order to use the heat obtained to preheat the reactant streams 1 and/or 2 by means of the heat exchanger 5a.

The plant shown in FIG. 2 comprises a hydrodechlorination reactor 3 comprising a reaction chamber 21 arranged within a heating space 15, and a flow tube 22 which projects into the reaction chamber 21 and through which the reactant streams 1 and/or 2 can be conducted into the reaction chamber 21, a line 4 which is conducted out of the hydrodechlorination reactor 3 and is for a trichlorosilane-containing and HCl-containing product mixture, a heat exchanger 5 through which the product mixture line 4 and the silicon tetrachloride line 1 and the hydrogen line 2 are conducted, such that heat transfer is possible from the product mixture line 4 into the silicon tetrachloride line 1 and into the hydrogen line 2. The plant further comprises a component plant 7 for removal of silicon tetrachloride 8, of trichlorosilane 9, of hydrogen 10 and of HCl 11. The silicon tetrachloride removed is conducted through line 8 into the silicon tetrachloride line 1, the trichlorosilane removed is supplied through line 9 to an end product withdrawal, the hydrogen removed is conducted through line 10 into the hydrogen line 2, and the HCl removed is supplied through line 11 to a plant 12 for hydrochlorination of silicon. The plant further comprises a condenser 13 for removal of the hydrogen coproduct which originates from the reaction in the hydrochlorination plant 12, this hydrogen being conducted through the hydrogen line 2 via the heat exchanger 5 into the hydrodechlorination reactor 3. Also shown is a distillation plant 14 for removal of silicon tetrachloride 1 and trichlorosilane (TCS), and also low boilers (LB) and high boilers (HB), from the product mixture, which comes from the hydrochlorination plant 12 via the condenser 13. The plant finally also comprises a recuperator 16 which preheats the combustion air 19 provided for the heating space 15 with the flue gas 20 flowing out of the heating space 5, and a plant 17 for raising steam with the aid of the flue gas 20 which flows out of the recuperator 16.

### EXAMPLES

### COMPARATIVE EXAMPLE

### Reaction Without Integrated Heat Exchanger

The reaction tube used was a tube of SSiC with a length of 1400 mm and an internal diameter of 16 mm. The reaction tube was equipped on the outside with an electrical heating jacket. The temperature measurement showed a constant temperature of 900° C. over a tube length of 400 mm. This region was considered to be the reaction zone. The reaction tube was covered with a Pt-containing catalyst layer. The reaction tube was charged with rings of SSiC, which had a diameter of 9 mm and a height of 9 mm. For catalyst forming, the reactor tube was brought to a temperature of 900° C., in the course of which nitrogen was passed through the reaction tube at 3 bar absolute. After two hours, the nitrogen was replaced by hydrogen. After a further hour in the hydrogen stream, likewise at 4 bar absolute, silicon tetrachloride was pumped into the reaction tube. The amount (“STC feed flow rate”) was varied in comparative examples CE1 to CE3 according to Table 1. The hydrogen flow rate was set to a molar excess of 4 to 1. The reactor output was analysed by online gas chromatography and this was used to calculate the silicon tetrachloride conversion and the molar selectivity for trichlorosilane. The results (“STC conversion” and “TCS in the product”) are reported in Table 1 and additionally shown graphically in FIG. 3.

### INVENTIVE EXAMPLE

### Reaction With Integrated Heat Exchanger

The reaction tube used was a tube of SSiC with a length of 1400 mm and an internal diameter of 16 mm. The reaction tube was equipped on the outside with an electrical heating jacket. The temperature measurement showed a constant temperature of 900° C. over a tube length of 400 mm. This region was considered to be the reaction zone. The reaction tube was covered with a Pt-containing catalyst layer. A second tube of SSiC which was conducted into the reaction tube had an external diameter of 5 mm and a wall thickness of 1.5 mm. This tube was uncoated. Through this inner tube, the STC and the hydrogen were introduced from the bottom. The reactant mixture flowed upward within the inner tube and was heated. Through the opening of the inner tube, it then flowed into the reaction zone. The product mixture was conducted out of the reaction tube at the bottom. For catalyst forming, the reactor tube was brought to a temperature of 900° C., in the course of which nitrogen was passed through the reaction tube at 3 bar absolute. After two hours, the nitrogen was replaced by hydrogen. After a further hour in the hydrogen stream, likewise at 4 bar absolute, silicon tetrachloride was pumped into the reaction tube. The amount (“STC feed flow rate”) was varied in examples 1 to 3 according to Table 1. The hydrogen flow rate was set to a molar excess of 4 to 1. The reactor output was analysed by online gas chromatography and this was used to calculate the silicon tetrachloride conversion and the molar selectivity for trichlorosilane. The results (“STC conversion” and “TCS in the product”) are reported in Table 1 and additionally shown graphically in FIG. 3.

TABLE 1
Experimental conditions and results

| | | Pressure | STC feed | H2 inflow | STC | TCS in the |
|---|---|---|---|---|---|---|
| | Temp. | [bar | flow rate | rate | conversion | product |
| No. | [° C.] | abs.] | [ml/min] | [l/min] | [%] | [Ma %] |
| 1 | 900 | 4 | 5.4 | 5.30 | 18.3 | 14.5 |
| 2 | 900 | 4 | 4.1 | 3.91 | 19.5 | 15.4 |
| 3 | 900 | 4 | 2.0 | 1.95 | 23.0 | 18.2 |
| CE 1 | 900 | 4 | 4.5 | 3.95 | 12.4 | 9.9 |
| CE 2 | 900 | 4 | 2.3 | 1.97 | 17.4 | 13.4 |
| CE 3 | 900 | 4 | 1.2 | 0.98 | 21.2 | 17.2 |

### LIST OF REFERENCE NUMERALS

(1) silicon tetrachloride-containing reactant stream
(2) hydrogen-containing reactant stream
(1,2) common reactant stream
(3) hydrodechlorination reactor
(4) product stream
(5,5a) integrated heat exchanger
(6) cooled product stream
(7) downstream component plant
(7a,7b,7c) arrangement of several component plants
(8) silicon tetrachloride stream removed in (7) or (7a, 7b, 7c)
(9) end product stream removed in (7) or (7a, 7b, 7c)
(10) hydrogen stream removed in (7) or (7a, 7b, 7c)
(11) HCl stream removed in (7) or (7a, 7b, 7c)
(12) upstream hydrochlorination process or plant
(13) condenser
(14) distillation plant
(15) heating jacket or heating space or combustion chamber
(16) recuperator
(17) plant for raising steam
(18) combustion gas
(19) combustion air
(20) flue gas
(21) reaction chamber
(22) flow tube

1. A process for reacting a silicon tetrachloride-comprising reactant stream and a hydrogen-comprising reactant stream the process comprising:
conducting the silicon tetrachloride-comprising reactant stream, the hydrogen-comprising reactant stream, or a combination thereof into a reaction chamber of a hydrodechlorination reactor via a flow tube and supplying heat through a heating jacket or heating space, thereby obtaining a product mixture comprising trichlorosilane and HCl under pressure;
conducting the product mixture out of the reaction chamber as a pressurized stream such that a reactant/product stream in the reaction chamber is conducted at least partly along an outside of the flow tube, and
cooling the product mixture with an integrated heat exchanger, thereby preheating the silicon tetrachloride-comprising reactant stream, the hydrogen-containing reactant stream, or the combination thereof,
wherein the reaction chamber and optionally the flow tube comprise a ceramic material,
the heating jacket or the heating space at least partly surrounds the reaction chamber (21), and
the reaction chamber comprises the integrated heat exchanger downstream of a region of the reaction chamber heated by the heating jacket or the heating space.

2. The process according to claim 1,
wherein the conducting the silicon tetrachloride-comprising reactant stream, the hydrogen-comprising reactant stream, or the combination thereof comprises:
conducting the silicon tetrachloride-comprising reactant stream and the hydrogen-comprising reactant stream together through a single flow tube;
conducting the silicon tetrachloride-comprising reactant stream and the hydrogen-comprising reactant stream together into the reaction chamber in each of more than one flow tube, or
conducting silicon tetrachloride-comprising reactant stream and the hydrogen-comprising reactant stream separately into the reaction chamber in different flow tubes.

3. The process according to claim 1,
wherein the ceramic material is Al₂O₃, AlN, Si₃N₄, SiCN, or SiC.

4. The process according to claim 3,
wherein the ceramic material is Si-infiltrated SiC, isostatically pressed SiC, hot isostatically pressed SiC, or SiC sintered at ambient pressure (SSiC).

5. The process according to claim 1,
wherein the reaction chamber, the flow tube, or a combination thereof comprises the SiC sintered at ambient pressure (SSiC).

6. The process according to claim 1,
wherein the silicon tetrachloride-comprising reactant stream, the hydrogen-comprising reactant stream, or the combination thereof is conducted into the hydrodechlorination reactor at a pressure from 1 to 10 bar and a temperature from 150° C. to 900° C.

7. The process according to claim 1,
wherein the silicon tetrachloride-comprising reactant stream is conducted into the hydrodechlorination reactor separately from the hydrogen-comprising reactant stream and the silicon tetrachloride-comprising reactant stream is liquid or gaseous.

8. The process according to claim 1,
wherein either
the supplying heat comprises heating with the heating jacket which is heated by electrical resistance heating or
the supplying heat comprises heating with the heating space, which is a combustion chamber operated with combustion gas and combustion air.

9. The process according to claim 1,
wherein an internal coating catalyzes a reaction in the reaction chamber, a coating catalyzes a reaction in a fixed bed in the reaction chamber, or both.

10. A method for preparing trichlorosilane from metallurgical silicon as an integral part of a trichlorosilane preparation plant the method comprising:
operating a hydrodechlorination reactor under pressure;
conducting a reactant/product stream within a reaction chamber such that the reactant/product stream is conducted at least partly along an outside of a flow tube; and
supplying heat through a heating jacket or heating space,
wherein the hydrodechlorination reactor comprises the flow tube which projects into the reaction chamber,
the reaction chamber and optionally the flow tube comprise a ceramic material,
the heating jacket or the heating space at least partly surrounds the reaction chamber, and
the reaction chamber comprises an integrated heat exchanger suitable for cooling a product mixture downstream of a region of the reaction chamber heated by the heating jacket or the heating space.

11. The method according to claim 10,
wherein the trichlorosilane preparation plant comprises:
a) a first component plant suitable for preparing silicon tetrachloride with hydrogen, thereby obtaining trichlorosilane, the first component plant comprising:
the hydrodechlorination reactor comprising the reaction chamber;
either a first line suitable for a silicon tetrachloride-comprising reactant stream and a second line suitable for a hydrogen-comprising reactant stream, both of which lead into the hydrodechlorination reactor, or a common line suitable for both the silicon tetrachloride-comprising reactant stream and the hydrogen-comprising reactant stream;
the flow tube suitable for conducting the silicon tetrachloride-comprising reactant stream, the hydrogen-comprising reactant stream, or a combination thereof into the reaction chamber;
an outlet suitable for conducting the product mixture out of the reaction chamber during operation of the trichlorosilane preparation plant;
a third line which is conducted out of the hydrodechlorination reactor and is suitable for the product mixture;
the integrated heat exchanger integrated within the hydrodechlorination reactor and suitable for conducting the third line and the first line the second line, or both such that heat is transferred from the third line into the first line the second line for or the both;
optionally a component plant or an arrangement comprising several component plants suitable for separately removing a product comprising silicon tetrachloride, trichlorosilane, hydrogen, or HCl;
optionally a fourth line suitable for removing silicon tetrachloride into the first line;
optionally a fifth line for removing trichlorosilane, thereby supplying to an end product withdrawal therethrough;
optionally a sixth line suitable for removing hydrogen into the second line; and
optionally a seventh line suitable for removing HCl, thereby supplying to a silicon hydrochlorination plant therethrough; and
b) a second component plant suitable for reacting metallurgical silicon with HCl, thereby obtaining silicon tetrachloride, the second component plant comprising:
the silicon hydrochlorination plant connected upstream of the first component plant, optionally suitable for conducting at least a portion of HCl into the hydrochlorination plant via an HCl stream;
a condenser suitable for removing of at least a portion of hydrogen as coproduct from a reaction in the silicon hydrochlorination plant, wherein the hydrogen is conducted into the hydrodechlorination reactor via the second line; and
a distillation plant suitable for removing at least silicon tetrachloride and trichlorosilane from a remaining product mixture from the reaction in the silicon hydrochlorination plant, wherein the silicon tetrachloride is conducted into the hydrodechlorination reactor via the first line.

12. The process according to claim 6, wherein the silicon tetrachloride-comprising reactant stream, the hydrogen-comprising reactant stream, or the combination thereof is conducted into the hydrodechlorination reactor at a pressure from 3 to 8 bar.

13. The process according to claim 12, wherein the silicon tetrachloride-comprising reactant stream, the hydrogen-comprising reactant stream, or the combination thereof is conducted into the hydrodechlorination reactor at a pressure from 4 to 6 bar.

14. The process according to claim 6, wherein the silicon tetrachloride-comprising reactant stream, the hydrogen-comprising reactant stream, or the combination thereof is conducted into the hydrodechlorination reactor at a temperature from 300° C. to 800° C.

15. The process according to claim 14, wherein the silicon tetrachloride-comprising reactant stream, the hydrogen-comprising reactant stream, or the combination thereof is conducted into the hydrodechlorination reactor at a temperature from 500° C. to 700° C.

16. The process according to claim 11,
wherein the hydrochlorination reactor further comprises:
the heating space instead of the heating jacket;
a recuperator suitable for preheating combustion air provided for the heating space with flue gas flowing out of the heating space; and
a plant suitable for raising steam from the flue gas flowing out of the recuperator.
